(19) United States
(12) Patent Application Publication
(10) Pub. No.: US 2024/0190179 A1
(43) Pub. Date: Jun. 13, 2024

(54) SYSTEM FOR ESTIMATION OF TIRE TREAD DEPTH EMPLOYING WHEEL SPEED

(71) Applicant: The Goodyear Tire & Rubber Company, Akron, OH (US)

(72) Inventors: Kanwar Bharat Singh, Copley, OH (US); Hélder Magalhães da Costa, Colmar-Berg (LU); Armando Longobardi, Körperich (DE); Seyed Amin Sajadi Alamdari, Trier (DE)

(21) Appl. No.: 18/520,766

(22) Filed: Nov. 28, 2023

Related U.S. Application Data
(60) Provisional application No. 63/386,950, filed on Dec. 12, 2022.

(51) Int. Cl. B60C 11/24; B60C 23/06

(52) U.S. Cl. CPC B60C 11/246; B60C 11/243; B60C 23/062; B60C 2200/04

(57) ABSTRACT

A system for estimation of a depth of a tread of a tire supporting a vehicle includes a processor in electronic communication with an electronic control system of the vehicle. A wheel speed signal processing module is in electronic communication with the processor, receives measured wheel speed signals, and generates processed wheel speed signals from the measured wheel speed signals. A Fast Fourier Transform computation module receives the processed wheel speed signals and generates a Fast Fourier Transform curve. A summation module selects a predefined range of the Fast Fourier Transform curve, generates a reference curve from the predefined range of the Fast Fourier Transform curve, and determines a sum of residuals between a real-time Fast Fourier Transform curve and the reference curve. A regression model determines an estimate of tire tread depth from the sum of residuals.

### FIELD OF THE INVENTION

The invention relates generally to tire monitoring systems. More particularly, the invention relates to systems that predict or estimate wear of a tire. Specifically, the invention is directed to a system for estimating the tread depth of a tire employing wheel speed signals.

### BACKGROUND OF THE INVENTION

Tire wear plays an important role in vehicle factors such as safety, reliability, and performance. Tread wear, which refers to the loss of material from the tread of the tire, directly affects such vehicle factors. As a result, it is desirable to monitor and/or measure the amount of tread wear experienced by a tire, which indicates the tire wear state. The amount of tread wear is often represented by a remaining tread depth of the tire. It is to be understood that for the purpose of convenience, the terms “tread wear” and “tire wear” may be used interchangeably.

One approach to the monitoring and/or measurement of tread wear has been through the use of wear sensors disposed in the tire tread, which has been referred to as a direct method or approach. The direct approach to measuring tire wear from tire-mounted sensors has multiple challenges. Placing the sensors in an uncured or “green” tire to then be cured at high temperatures may impair the operation of the wear sensors. In addition, sensor durability can prove to be an issue in meeting the millions of cycles requirement for tires. Moreover, wear sensors in a direct measurement approach must be small enough not to cause any uniformity problems as the tire rotates at high speeds. Finally, wear sensors can be expensive and add significantly to the cost of the tire.

Due to such challenges, alternative approaches have been developed, which involve prediction of tread wear over the life of the tire, including indirect estimations of the tire wear state. These alternative approaches have experienced some disadvantages in the prior art due to a lack of optimum prediction techniques, which reduces the accuracy and/or reliability of the tread wear predictions. For example, many such techniques involve data or information that is not easily obtained, such as non-standard vehicle system signals, or data that is not accurate under all driving conditions.

In the prior art, one approach to an indirect estimation of the tire wear state has been to obtain a speed of a wheel on which the tire is mounted, which is referred to as a wheel speed signal. In this approach, the tire wear state has been determined from the wheel speed signal by correlating the wear state to a resonance frequency of the wheel speed signal. However, extraction of precise resonance frequencies from wheel speed signals may be challenging. For example, pulse width errors may be present, which are caused by manufacturing errors, wear of wheel speed sensor components, and corrosion of wheel speed sensor components. In addition, vibration disturbances from the engine and the driveline may creep into wheel speed measurements. Such challenges decrease the accuracy of the tire wear state determinations.

As a result, there is a need in the art for a system that accurately and reliably estimates the remaining tread depth on a tire.

### SUMMARY OF THE INVENTION

According to an aspect of an exemplary embodiment of the invention, a system for estimation of a depth of a tread of a tire supporting a vehicle is provided. The system includes a processor in electronic communication with an electronic control system of the vehicle. A wheel speed signal processing module is in electronic communication with the processor, receives measured wheel speed signals, and generates processed wheel speed signals from the measured wheel speed signals. A Fast Fourier Transform computation module is in electronic communication with the processor, receives the processed wheel speed signals, and generates a Fast Fourier Transform curve. A summation module is in electronic communication with the processor, selects a predefined range of the Fast Fourier Transform curve, generates a reference curve from the predefined range of the Fast Fourier Transform curve, and determines a sum of residuals between a real-time Fast Fourier Transform curve and the reference curve. A regression model is in electronic communication with the processor and determines an estimate of tire tread depth from the sum of residuals.

### BRIEF DESCRIPTION OF THE DRAWINGS

The invention will be described by way of example and with reference to the accompanying drawings, in which:

FIG. 1 is a schematic perspective view of a vehicle that includes tires employing an exemplary embodiment of a system for estimation of tire tread depth of the present invention;

FIG. 2 is a schematic representation of data transmission to a cloud-based server and to a device;

FIG. 3 is a schematic diagram of an exemplary embodiment of a system for estimation of tire tread depth of the present invention;

FIG. 4 is a graphical representation of aspects of the system for estimation of tire tread depth shown in FIG. 3;

FIG. 5 is a graphical representation of an additional aspect of the system for estimation of tire tread depth shown in FIG. 3;

FIG. 6 is a graphical representation of an additional aspect of the system for estimation of tire tread depth shown in FIG. 3;

FIG. 7 is a graphical representation of an additional aspect of the system for estimation of tire tread depth shown in FIG. 3;

FIG. 8 is a graphical representation of an additional aspect of the system for estimation of tire tread depth shown in FIG. 3; and

FIG. 9 is a graphical representation of an additional aspect of the system for estimation of tire tread depth shown in FIG. 3.

Similar numerals refer to similar parts throughout the drawings.

### Definitions

“ANN” or “artificial neural network” is an adaptive tool for non-linear statistical data modeling that changes its structure based on external or internal information that flows through a network during a learning phase, used to model complex relationships between inputs and outputs or to find patterns in data.

“Axial” and “axially” means lines or directions that are parallel to the axis of rotation of the tire.

“CAN bus” or “CAN bus system” is an abbreviation for controller area network system, which is a vehicle bus standard designed to allow microcontrollers and devices to communicate with each other within a vehicle without a host computer.

“Circumferential” means lines or directions extending along the perimeter of the surface of the annular tread perpendicular to the axial direction.

“Equatorial centerplane” means the plane perpendicular to the tire's axis of rotation and passing through the center of the tread.

“Footprint” means the contact patch or area of contact created by the tire tread with a flat surface as the tire rotates or rolls.

“Groove” is a continuous channel molded or cut into the tread.

“Inboard side” means the side of the tire nearest the vehicle when the tire is mounted on a wheel and the wheel is mounted on the vehicle.

“Lateral” means an axial direction.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Tread” is the portion of the tire that comes into contact with the road.

“Tread depth” is the radial distance measured from the tread surface to the bottom of the grooves.

“Tread element” or “traction element” means a rib or a block element defined by a shape having adjacent grooves.

### DETAILED DESCRIPTION OF THE INVENTION

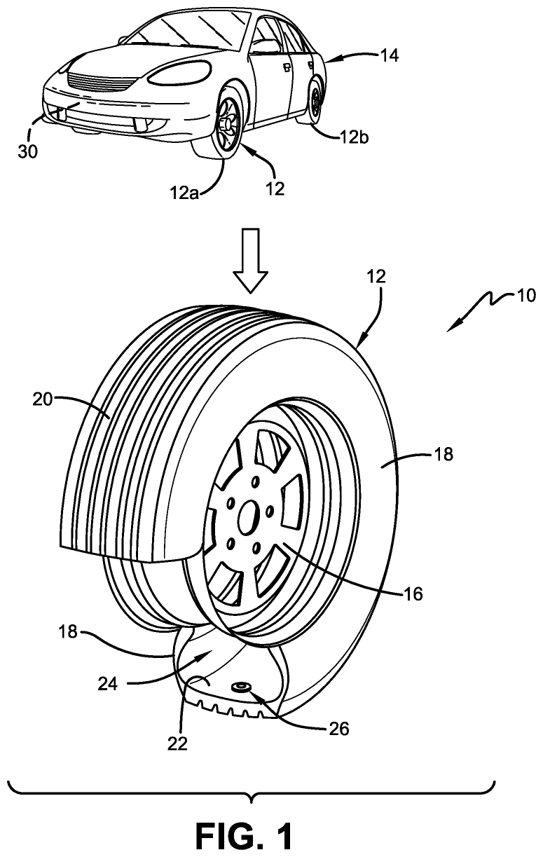

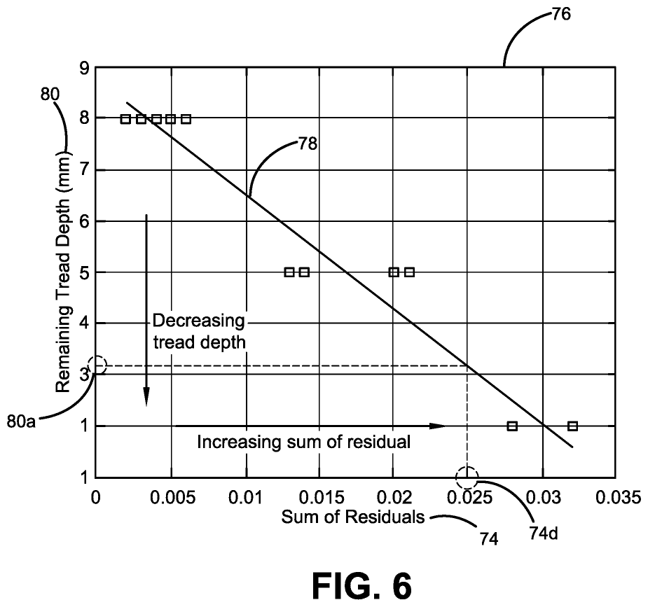

With reference to FIGS. 1 through 9, an exemplary embodiment of the system for estimation of tire tread depth of the present invention is indicated at 10. With particular reference to FIG. 1, the system 10 estimates a tread depth 80 (FIG. 6) of each tire 12 supporting a vehicle 14. When the tires 12 are disposed in a front position on the vehicle 14, they are referred to as front tires 12a. When the tires 12 are disposed in a rear position on the vehicle 14, they are referred to as rear tires 12b. While the vehicle 14 is depicted as a passenger car, the invention is not to be so restricted. The principles of the invention find application in other vehicle categories, such as commercial trucks, in which vehicles may be supported by more or fewer tires than those shown in FIG. 1.

The tires 12 are of conventional construction, and each tire is mounted on a respective wheel 16 as known to those skilled in the art. Each tire 12 includes a pair of sidewalls 18 that extend to a circumferential tread 20, which wears with age from road abrasion. A measure of the wear on the tire 12 is the remaining tread depth 80. An innerliner 22 is disposed on the inner surface of the tire 12, and when the tire is mounted on the wheel 16, an internal cavity 24 is formed, which is filled with a pressurized fluid, such as air.

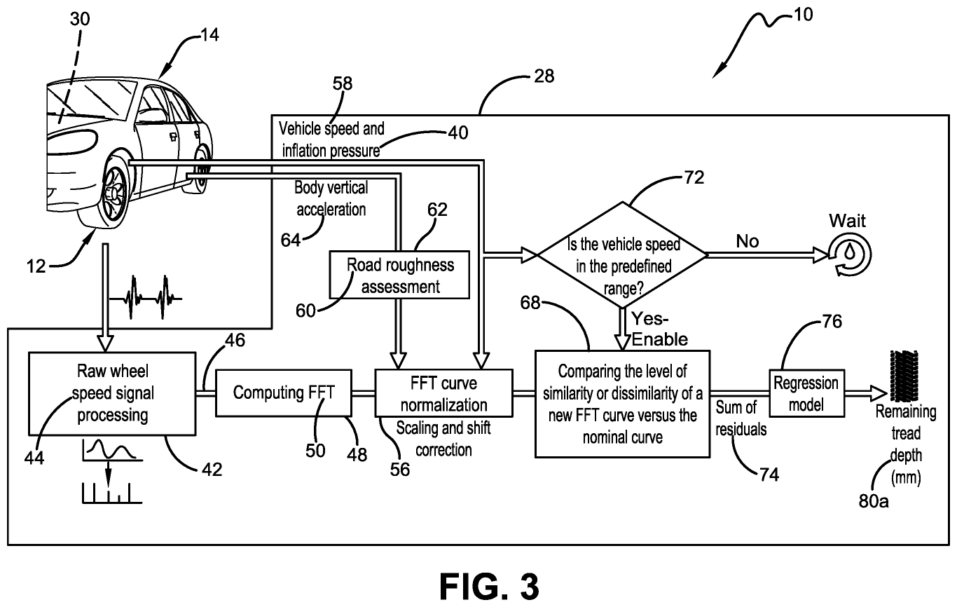

A tire sensor unit 26 may be attached to the innerliner 22 of each tire 12 by means such as an adhesive, and measures certain parameters or conditions of the tire, such as tire pressure 40 (FIG. 3) and/or tire temperature, and may be of any known configuration. It is to be understood that the tire sensor unit 26 may be attached in such a manner, or to other components of the tire 12, such as on or in one of the sidewalls 18, on or in the tread 20, and/or on the wheel 16. The tire sensor unit 26 preferably also includes electronic memory capacity for storing identification (ID) information for each tire 12, known as tire ID information.

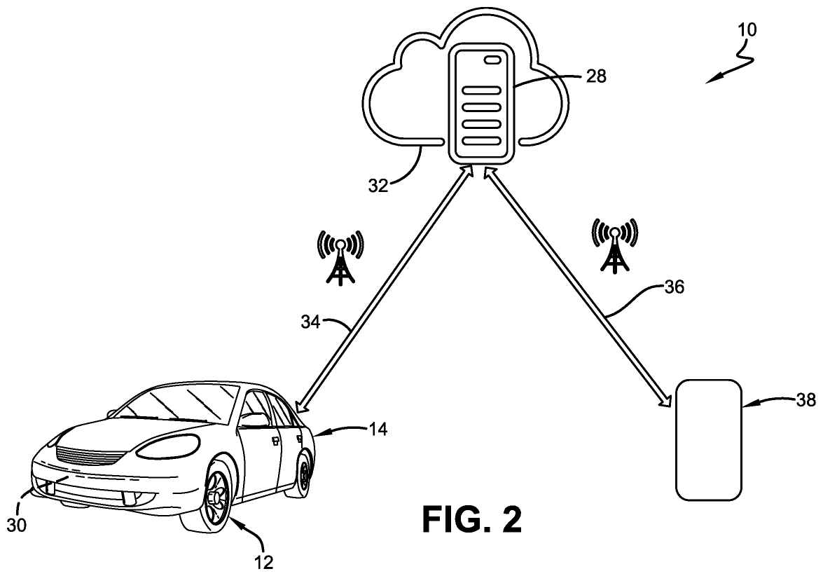

Turning to FIG. 2, aspects of the system for estimation of tire tread depth 10 preferably are executed on a processor 28. The processor 28 enables input of parameters and execution of specific techniques, to be described below, which are stored in a suitable storage medium and are in electronic communication with the processor. The processor 28 may be mounted on the vehicle 14, may be in communication with an electronic control system 30 of the vehicle, such as the vehicle CAN bus system, and/or may be a remote processor in a cloud-based server 32.

Wireless transmission means 34, such as an antenna, may wirelessly send data from sensors that are in electronic communication with the vehicle electronic control system 30 to the processor 28. Output from the system 10 may be wirelessly transmitted by an antenna 36 from the processor 28 to a display or controller device 38 and/or to the electronic control system 30 of the vehicle 14. By way of example, the device 38 may include a device that is accessible to a user of the vehicle 14 or a technician for the vehicle, such as a smartphone, and/or a device that is accessible to a fleet manager, such as a computer.

Turning to FIG. 3, the system for estimation of tire tread depth 10 includes a wheel speed signal processing module 42, which is stored on or is in electronic communication with the processor 28. The wheel speed signal processing module 42 receives a raw measured wheel speed signal 44 from an electronic control system 30 of the vehicle 14, such as the vehicle CAN bus. The wheel speed signal processing module 42 preferably compiles data sets according to timestamps, which are digital identifications of each time at which a measured wheel speed signal 44 is transmitted to the wheel speed signal processing module. The wheel speed signal processing module 42 generates processed wheel speed signals 46.

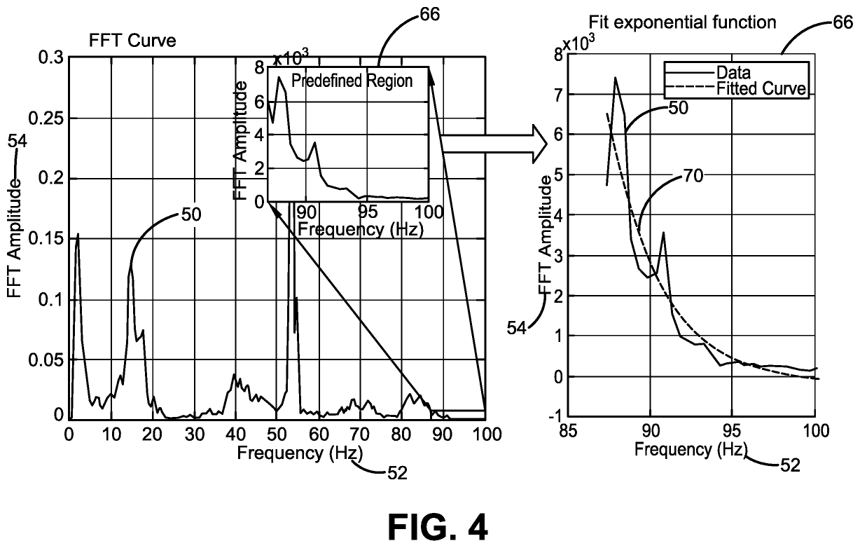

The processed wheel speed signals 46 are communicated or transmitted from the wheel speed signal processing module 42 to a Fast Fourier Transform computation module 48, which is stored on or is in electronic communication with the processor 28. With additional reference to FIG. 4, the Fast Fourier Transform computation module 48 generates a Fast Fourier Transform curve 50, which is a plot of frequency 52 of the processed wheel speed signals 46 versus a Fast Fourier Transform amplitude 54 of the processed wheel speed signals. To generate the Fast Fourier Transform curve 50, the Fast Fourier Transform computation module 48 converts the processed wheel speed signals 46 from their original time domain to a representation in the frequency domain.

Returning to FIG. 3, once the Fast Fourier Transform computation module 48 generates the Fast Fourier Transform curve 50, a normalization module 56 may optionally normalize the Fast Fourier Transform curve. The normalization module 56 is stored on or is in electronic communication with the processor 28 and accounts for impacts by certain factors upon the Fast Fourier Transform amplitude 54. By way of example, the factors may include the tire inflation pressure 40, a speed 58 of the vehicle 14, and a roughness 60 of the road over which the vehicle travels. The normalization module 56 executes scaling and shift correction to adjust the values of the Fast Fourier Transform amplitude 54 to a common scale to account for these factors.

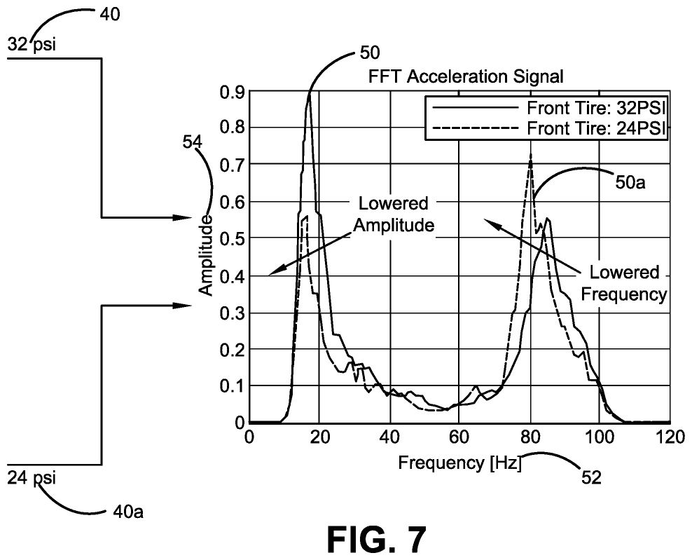

With additional reference to FIG. 7, the impact of a change in tire pressure 40 on the Fast Fourier Transform curve 50 is shown. A lower pressure 40a on the front tires 12a results in a Fast Fourier Transform curve 50a with lower wheel hop acceleration levels for the front tires than for the rear tires 12b. The values of the Fast Fourier Transform amplitude 54 are normalized by inputting the inflation pressure 40 from the tire sensor unit 26, which enables adjustment of the amplitude to a common pressure scale.

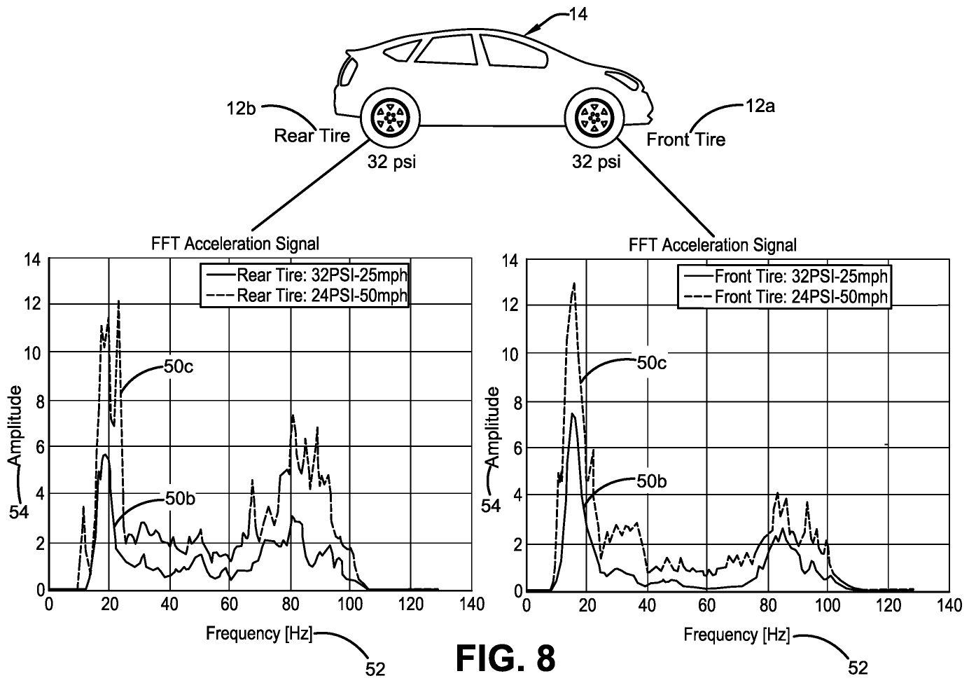

Referring now to FIGS. 3 and 8, the impact of the speed 58 of the vehicle 14 on the Fast Fourier Transform curve 50 is shown. Because acceleration amplitudes scale linearly with speed, as the speed 58 of the vehicle 14 increases, the amplitude of the Fast Fourier Transform curve increases from a first level 50b to a second level 50c. The values of the Fast Fourier Transform amplitude 54 are normalized by employing the vehicle speed 58 from an electronic control system 30 of the vehicle 14, such as the vehicle CAN bus. Use of the vehicle speed 58 thus enables the Fast Fourier Transform amplitudes 54 to be scaled according to speed.

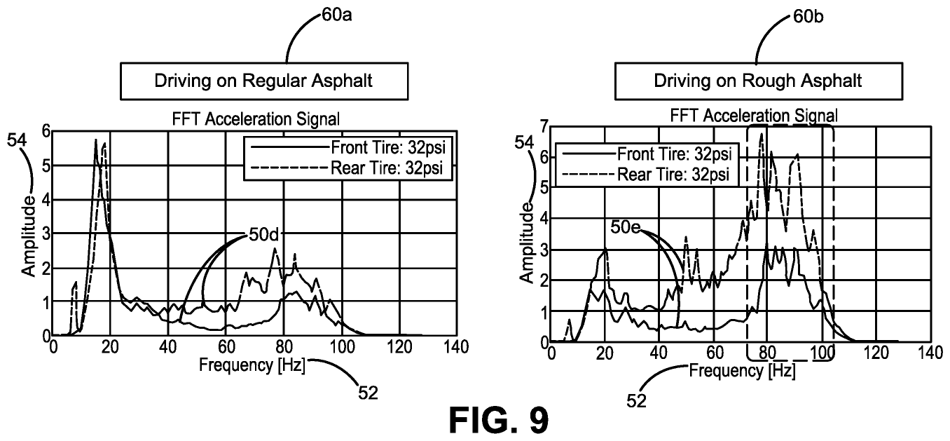

The impact of the roughness 60 of the road on the Fast Fourier Transform curve 50 is shown in FIGS. 3 and 9. When the vehicle 14 travels over road with a low roughness 60a, the amplitude of the Fast Fourier Transform curve is at a first level 50d. When the vehicle 14 travels over a road with a high roughness 60b, the amplitude of the Fast Fourier Transform curve increases to a second level 50e. The results reflect a large contribution of higher frequencies of the amplitude of the Fast Fourier Transform curve at the second level 50e due to a high road roughness 60b, indicating that the tire dynamics are of greater relevance on rough roads.

To normalize the values of the Fast Fourier Transform amplitude 54, a vertical acceleration 64 of the vehicle 14 is employed, which may be measured by an accelerometer. Vertical acceleration data 64 from the accelerometer may be communicated to the processor 28 from a telematics control unit in which the accelerometer is mounted, or from an electronic control system 30, such as the vehicle CAN bus system. The vertical acceleration 64 is input into a roughness assessment module 62, which is stored on or is in electronic communication with the processor 28 and correlates the vertical acceleration to the road roughness 60. For example, the roughness assessment module 62 may include pre-determined values of road roughness 60, which may be indicated by an international roughness index (IRI), and are correlated to certain values of vertical acceleration 64.

The values of the Fast Fourier Transform amplitude 54 are normalized by employing the road roughness 60 as determined by the roughness assessment module 62. Use of the road roughness 60 thus enables the Fast Fourier Transform amplitudes 54 to be scaled according to road roughness.

Returning to FIGS. 3 and 4, after any optional normalization of the Fast Fourier Transform curve 50 by the normalization module 56, a predefined region or range 66 of the curve is selected in a summation module 68. The summation module 68 is stored on or is in electronic communication with the processor 28. Preferably, the predefined range 66 is determined based on domain knowledge of the Fast Fourier Transform curve 50. For example, the predefined range 66 may be the portion of the Fast Fourier Transform curve 50 between about eighty (80) Hertz (Hz) and about one hundred (100) Hz, as there may be an expected shift in the torsional mode of the tire 12 in this frequency range.

Optionally, an evaluator 72, which is stored on or is in electronic communication with the processor 28, may receive the above-described vehicle speed 58. To ensure an optimum predefined range 66 is selected by the summation module 68, the evaluator 72 may evaluate the measured vehicle speed 58 to determine if the vehicle speed is in a predetermined acceptable range. If the vehicle speed 58 is in the predetermined range, operation of the summation module 68 is enabled. If the vehicle speed 58 is outside of the predetermined range, operation of the summation module 68 is suspended.

As shown in FIG. 4, once the predefined range 66 is selected, the summation module 68 generates a fitted reference curve 70. To generate the reference curve 70, the summation module 68 preferably fits a polynomial or an exponential function to the Fast Fourier Transform curve 50 in the predefined range 66 for a nominal or reference condition. Because the system for estimation of tire tread depth 10 concerns wear of the tire 12, the nominal or reference condition preferably is for a new tire, which is when the tread 20 is unworn and the tread depth 80 is at a known or maximum value.

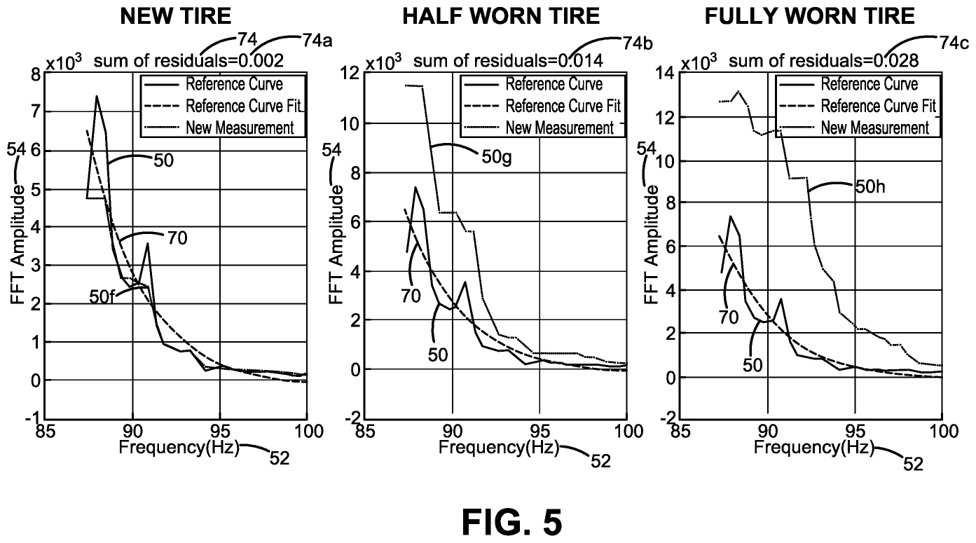

With reference to FIGS. 3 and 5, once the fitted reference curve 70 is generated by the summation module 68, a real-time Fast Fourier Transform curve 50f, 50g, 50h is generated in the same manner as described above for the Fast Fourier Transform curve 50. The summation module 68 compares the level of similarity of the predefined range 66 of the real-time Fast Fourier Transform curve 50f, 50g, 50h to the fitted reference curve 70 by determining a sum of residuals 74. The sum of residuals 74 is a measure of a discrepancy between variable data, which is the real-time Fast Fourier Transform curve 50f, 50g, 50h, and a model, which is the reference curve 70. A small value for the sum of residuals 74 indicates a tight fit of the variable data to the model. For example, a first real-time Fast Fourier Transform curve 50f yields a small sum of residuals 74a when the tire 12 is new. When the tire 12 is half worn, a second real-time Fast Fourier Transform curve 50g yields a larger sum of residuals 74b. When the tire 12 is fully worn, a third real-time Fast Fourier Transform curve 50g yields an even larger sum of residuals 74c.

Turning now to FIGS. 3 and 6, the sum of residuals 74 is employed in a regression model 76, which is stored on or is in electronic communication with the processor 28. The regression model 76 preferably employs linear regression to generate a linear relationship 78 between the sum of residuals 74 as the input variable and the remaining tread depth 80 as the response variable. In the linear relationship 78, as the sum of residuals 74 increases, the remaining tread depth 80 decreases. Thus, when the real-time Fast Fourier Transform curve 50f, 50g, 50h is used to determine a specific value 74d of the sum of residuals 74, the linear relationship 78 enables the regression model 68 to determine a specific value 80a for the remaining tire tread depth 80.

The value 80a of the remaining tire tread depth 80 may be wirelessly transmitted from the processor 28 to the display or controller device 38 and/or to the electronic control system 30 of the vehicle 14. The device 38 may include a device that is accessible to a user of the vehicle 14 or a technician for the vehicle, such as a smartphone, and/or a device that is accessible to a fleet manager, such as a computer. In this manner, the estimate of remaining tread depth 80a may be employed by various control systems that are in communication with the electronic control system 30 of the vehicle 14, by a user of the vehicle, by a technician, and/or by a fleet manager.

In this manner, the system for estimation of tire tread depth 10 accurately and reliably estimates the tread depth 80a that remains on a tire 12. The system 10 may execute an estimation of tread depth 80a for the front tires 12a and a separate estimation of tread depth for the rear tires 12b. Instead of extracting and comparing a particular resonance frequency, the system 10 estimates tread depth 80 using wheel speed signals 44 to generate a Fast Fourier Transform curve 50. The system 10 further employs a sum of residuals 74 between the real-time Fast Fourier Transform curve 50f, 50g, 50h and a reference curve 70 to generate a specific value 80a of remaining tread depth 80 on the tire 12. The system 10 is repeatable and may be employed across a wide variety of tires.

The present invention also includes a method for estimating the depth 80 of the tread 20 remaining on a tire 12. The method includes steps in accordance with the description that is presented above and shown in FIGS. 1 through 9.

It is to be understood that the structure of the above-described the system for estimation of tire tread depth may be altered or rearranged, or components or steps known to those skilled in the art omitted or added, without affecting the overall concept or operation of the invention. For example, electronic communication may be through a wired connection or wireless communication without affecting the overall concept or operation of the invention. Such wireless communications include radio frequency (RF) and Bluetooth® communications.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A system for estimation of a depth of a tread of a tire supporting a vehicle, the system comprising:
a processor in electronic communication with an electronic control system of the vehicle;
a wheel speed signal processing module in electronic communication with the processor, the wheel speed signal processing module receiving measured wheel speed signals and generating processed wheel speed signals from the measured wheel speed signals;
a Fast Fourier Transform computation module in electronic communication with the processor, the Fast Fourier Transform computation module receiving the processed wheel speed signals and generating a Fast Fourier Transform curve;
a summation module in electronic communication with the processor, the summation module selecting a predefined range of the Fast Fourier Transform curve, generating a reference curve from the predefined range of the Fast Fourier Transform curve, and determining a sum of residuals between a real-time Fast Fourier Transform curve and the reference curve; and
a regression model in electronic communication with the processor, the regression model determining an estimate of tire tread depth from the sum of residuals.

2. The system for estimation of a depth of a tread of a tire supporting a vehicle of claim 1, wherein the wheel speed signal processing module receives the wheel speed signal from an electronic control system of the vehicle.

3. The system for estimation of a depth of a tread of a tire supporting a vehicle of claim 1, wherein the Fast Fourier Transform curve includes a plot of frequency of the processed wheel speed signals versus a Fast Fourier Transform amplitude of the processed wheel speed signals.

4. The system for estimation of a depth of a tread of a tire supporting a vehicle of claim 1, further comprising a normalization module in electronic communication with the processor, the normalization module accounting for impacts upon the Fast Fourier Transform amplitude and normalizing the Fast Fourier Transform curve.

5. The system for estimation of a depth of a tread of a tire supporting a vehicle of claim 4, wherein the normalization module normalizes values of the Fast Fourier Transform amplitude to account for an impact from tire inflation pressure by employing a tire inflation pressure from a tire sensor unit.

6. The system for estimation of a depth of a tread of a tire supporting a vehicle of claim 5, wherein the normalization module adjusts values of the Fast Fourier Transform amplitude to a common pressure scale.

7. The system for estimation of a depth of a tread of a tire supporting a vehicle of claim 4, wherein the normalization module normalizes values of the Fast Fourier Transform amplitude to account for an impact from a speed of the vehicle by employing a vehicle speed measurement.

8. The system for estimation of a depth of a tread of a tire supporting a vehicle of claim 7, wherein the normalization module scales values of the Fast Fourier Transform amplitude according to the speed of the vehicle.

9. The system for estimation of a depth of a tread of a tire supporting a vehicle of claim 4, wherein the normalization module normalizes values of the Fast Fourier Transform amplitude to account for an impact from a roughness of a road over which the vehicle travels.

10. The system for estimation of a depth of a tread of a tire supporting a vehicle of claim 9, wherein the normalization module scales values of the Fast Fourier Transform amplitude according to road roughness.

11. The system for estimation of a depth of a tread of a tire supporting a vehicle of claim 10, further comprising a roughness assessment module in electronic communication with the processor, the roughness assessment module receiving a vehicle vertical acceleration and correlating the vertical acceleration to the road roughness.

12. The system for estimation of a depth of a tread of a tire supporting a vehicle of claim 11, wherein the vehicle vertical acceleration is measured by an accelerometer.

13. The system for estimation of a depth of a tread of a tire supporting a vehicle of claim 11, wherein the roughness assessment module includes pre-determined values of road roughness correlated to values of vertical acceleration.

14. The system for estimation of a depth of a tread of a tire supporting a vehicle of claim 1, wherein the summation module determines the predefined range of the Fast Fourier Transform curve based on domain knowledge.

15. The system for estimation of a depth of a tread of a tire supporting a vehicle of claim 1, further comprising an evaluator, the evaluator receiving a vehicle speed and determining whether the vehicle speed is in a predetermined acceptable range, the evaluator enabling operation of the summation module when the vehicle speed is in the predetermined acceptable range.

16. The system for estimation of a depth of a tread of a tire supporting a vehicle of claim 1, wherein the summation module fits at least one of a polynomial function and an exponential function to the Fast Fourier Transform curve in the predefined range to generate the reference curve.

17. The system for estimation of a depth of a tread of a tire supporting a vehicle of claim 1, wherein the reference curve is based upon a reference condition for a new tire.

18. The system for estimation of a depth of a tread of a tire supporting a vehicle of claim 1, wherein the regression model employs linear regression to generate a linear relationship between the sum of residuals and tread depth.

19. The system for estimation of a depth of a tread of a tire supporting a vehicle of claim 1, wherein the estimate of tire tread depth is transmitted from the processor to at least one of a display device, a controller device, and an electronic control system of the vehicle.

20. The system for estimation of a depth of a tread of a tire supporting a vehicle of claim 1, wherein the processor is at least one of a vehicle-mounted processor and a remote processor.
